(19) United States
(12) Patent Application Publication
(10) Pub. No.: US 2025/0236294 A1
(43) Pub. Date: Jul. 24, 2025

(54) TRAVELING CONTROL DEVICE, TRAVELING CONTROL METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Masamichi Ohsugi, Sunto-gun Shizuoka-ken (JP)

(73) Assignee: TOYOTA JIDOSHA KABUSHIKI KAISHA, Toyota-shi Aichi-ken (JP)

(21) Appl. No.: 19/028,410

(22) Filed: Jan. 17, 2025

(30) Foreign Application Priority Data
Jan. 23, 2024 (JP) 2024-008246

(51) Int. Cl. B60W 30/14; B60W 30/18; B60W 50/00

(52) U.S. Cl. CPC B60W 30/146; B60W 30/18163; B60W 50/0097; B60W 2554/4042; B60W 2554/4046

(57) ABSTRACT

A traveling control device calculates a change in traveling behavior of a following vehicle in a time period before and after a time point when a right turn blinker of a host vehicle is turned on based on the result of detection of a surrounding situation sensor detecting a surrounding situation of the host vehicle driving on the right side of a road, the surrounding situation including the following vehicle positioned within a certain distance behind the host vehicle, and predicts the traveling behavior of the following vehicle before the host vehicle turns right or while the host vehicle is turning right based on the change in the traveling behavior of the following vehicle in the time period before and after the time point when the right turn blinker of the host vehicle is turned on.

### CROSS-REFERENCE TO RELATED APPLICATIONS

This application claims priority to Japanese Patent Application No. 2024-008246 filed Jan. 23, 2024, the entire contents of which are herein incorporated by reference.

### FIELD

The present disclosure relates to traveling control device, traveling control method, and non-transitory recording medium.

### BACKGROUND

PTL 1 (Japanese Unexamined Patent Publication No. 2019-212095) describes to investigate whether it is possible for a following vehicle to slip through the left side of a host vehicle when the host vehicle turns left at an intersection of a road in which left-hand side driving is regulated.

In the art described in PTL 1, the type of the following vehicle is recognized and identified, the presence of the following vehicle is identified, the distance and relative speed of the host vehicle and following vehicle are calculated, passing (slip through) of the following vehicle is recognized, whether the following vehicle is trying to turn left in the same way as the host vehicle is investigated (whether a left turn blinker is turned on is confirmed), and whether the following vehicle is trying to slip through the left side of the host vehicle and go straight is determined, but traveling behavior of the following vehicle before the host vehicle turns left or while the host vehicle is turning left is not predicted based on the change in the traveling behavior of the following vehicle in the time period before and after the time point when the left turn blinker of the host vehicle is turned on.

That is, in the art described in PTL 1, just the current behavior of the following vehicle is recognized. The future behavior of the following vehicle is not predicted. For this reason, in the art described in PTL 1, it is liable to be impossible to suitably control the host vehicle in accordance with the behavior of the following vehicle. That is, in the art described in PTL 1, control of traveling of the host vehicle is liable to end up being delayed relative to a change in behavior of the following vehicle.

### SUMMARY

Considering the above-mentioned point, the present disclosure has as its object the provision of traveling control device, traveling control method, and non-transitory recording medium able to suitably control traveling of a host vehicle in accordance with behavior of a following vehicle.
(1) One aspect of the present disclosure is a traveling control device including a processor configured to: acquire result of detection of a surrounding situation sensor detecting a surrounding situation of a host vehicle driving on the right side of a road, the surrounding situation including a following vehicle positioned within a certain distance behind the host vehicle; calculate a change in traveling behavior of the following vehicle in a time period before and after a time point when a right turn blinker of the host vehicle is turned on based on the result of detection; and predict the traveling behavior of the following vehicle before the host vehicle turns right or while the host vehicle is turning right based on the change in the traveling behavior of the following vehicle in the time period before and after the time point when the right turn blinker of the host vehicle is turned on.
(2) In the traveling control device of the aspect (1), the processor may be configured to control traveling of the host vehicle before the host vehicle turns right based on the traveling behavior of the following vehicle before the host vehicle turns right or while the host vehicle is turning right.
(3) In the traveling control device of the aspect (1) or (2), the processor may be configured to predict that the following vehicle is waiting for the host vehicle to finish turning right when the width direction position of the following vehicle in a traveling lane in the time period before and after the time point when the right turn blinker is turned on does not change and when the speed of the following vehicle in the time period after the time point when the right turn blinker is turned on is lower than the speed of the following vehicle in the time period before the time point when the right turn blinker is turned on.
(4) In the traveling control device of any one of the aspects (1) to (3), the processor may be configured to make the host vehicle decelerate and make the width direction position of the host vehicle in the traveling lane gradually move to the right side when the processor predicts that the following vehicle is waiting for the host vehicle to finish turning right.
(5) In the traveling control device of any one of the aspects (1) to (4), the processor may be configured to predict that there is a possibility that the following vehicle slips through the right side of the host vehicle when the width direction position of the following vehicle in the traveling lane in the time period before and after the time point when the right turn blinker is turned on does not change or the width direction position of the following vehicle in the traveling lane in the time period after the time point when the right turn blinker is turned on moves to the right side of the width direction position of the following vehicle in the traveling lane in the time period before the time point when the right turn blinker is turned on and when the speed of the following vehicle in the time period after the time point when the right turn blinker is turned on is higher than the speed of the following vehicle in the time period before the time point when the right turn blinker is turned on.
(6) In the traveling control device of any one of the aspects (1) to (5), the processor may be configured to make the host vehicle decelerate without making the width direction position of the host vehicle in the traveling lane change when the processor predicts that there is the possibility that the following vehicle slips through the right side of the host vehicle.
(7) In the traveling control device of any one of the aspects (1) to (6), the processor may be configured to predict that the following vehicle is waiting for the host vehicle to finish turning right or there is a possibility that the following vehicle slips through the right side of the host vehicle when the width direction position of the following vehicle in the traveling lane in the time period before and after the time point when the right turn blinker is turned on does not change and when the speed of the following vehicle in the time period before and after the time point when the right turn blinker is turned on does not change.
(8) In the traveling control device of any one of the aspects (1) to (7), the processor may be configured to perform control for making the host vehicle decelerate without making the width direction position of the host vehicle in the traveling lane change when the processor predicts that the following vehicle is waiting for the host vehicle to finish turning right or there is the possibility that the following vehicle slips through the right side of the host vehicle.
(9) In the traveling control device of any one of the aspects (1) to (8), the processor may be configured to predict that the following vehicle is waiting for the host vehicle to finish turning right when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is lower than the speed of the following vehicle in the time period before the time point when the processor performs the control for making the host vehicle decelerate without making the width direction position of the host vehicle in the traveling lane change.
(10) In the traveling control device of any one of the aspects (1) to (9), the processor may be configured to predict that there is the possibility that the following vehicle slips through the right side of the host vehicle when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is not lower than the speed of the following vehicle in the time period before the time point when the processor performs the control for making the host vehicle decelerate without making the width direction position of the host vehicle in the traveling lane change.
(11) In the traveling control device of any one of the aspects (1) to (10), the processor may be configured to predict that the following vehicle is waiting for the host vehicle to finish turning right or there is a possibility that the following vehicle slips through the right side of the host vehicle when the width direction position of the following vehicle in the traveling lane in the time period after the time point when the right turn blinker is turned on moves to the right side of the width direction position of the following vehicle in the traveling lane in the time period before the time point when the right turn blinker is turned on and when the speed of the following vehicle in the time period after the time point when the right turn blinker is turned on is lower than the speed of the following vehicle in the time period before the time point when the right turn blinker is turned on.
(12) In the traveling control device of any one of the aspects (1) to (11), the processor may be configured to perform control for making the host vehicle decelerate without making the width direction position of the host vehicle in the traveling lane change when the processor predicts that the following vehicle is waiting for the host vehicle to finish turning right or there is the possibility that the following vehicle slips through the right side of the host vehicle.
(13) In the traveling control device of any one of the aspects (1) to (12), the processor may be configured to predict that the following vehicle is waiting for the host vehicle to finish turning right when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is lower than the speed of the following vehicle in the time period before the time point when the processor performs the control for making the host vehicle decelerate without making the width direction position of the host vehicle in the traveling lane change.
(14) In the traveling control device of any one of the aspects (1) to (13), the processor may be configured to predict that there is the possibility that the following vehicle slips through the right side of the host vehicle when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is not lower than the speed of the following vehicle in the time period before the time point when the processor performs the control for making the host vehicle decelerate without making the width direction position of the host vehicle in the traveling lane change.
(15) In the traveling control device of any one of the aspects (1) to (14), the processor may be configured to predict that the following vehicle is waiting for the host vehicle to finish turning right or there is a possibility that the following vehicle slips through the right side of the host vehicle when the width direction position of the following vehicle in the traveling lane in the time period after the time point when the right turn blinker is turned on moves to the right side of the width direction position of the following vehicle in the traveling lane in the time period before the time point when the right turn blinker is turned on and when the speed of the following vehicle in the time period before and after the time point when the right turn blinker is turned on does not change.
(16) In the traveling control device of any one of the aspects (1) to (15), the processor may be configured to perform control for making the host vehicle decelerate without making the width direction position of the host vehicle in the traveling lane change when the processor predicts that the following vehicle is waiting for the host vehicle to finish turning right or there is the possibility that the following vehicle slips through the right side of the host vehicle.
(17) In the traveling control device of any one of the aspects (1) to (16), the processor may be configured to predict that the following vehicle is waiting for the host vehicle to finish turning right when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is lower than the speed of the following vehicle in the time period before the time point when the processor performs the control for making the host vehicle decelerate without making the width direction position of the host vehicle in the traveling lane change.
(18) In the traveling control device of any one of the aspects (1) to (17), the processor may be configured to predict that there is the possibility that the following vehicle slips through the right side of the host vehicle when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is not lower than the speed of the following vehicle in the time period before the time point when the processor performs the control for making the host vehicle decelerate without making the width direction position of the host vehicle in the traveling lane change.
(19) In the traveling control device of any one of the aspects (1) to (18), the processor may be configured to predict that there is a possibility that the following vehicle overtakes the host vehicle from the left side of the host vehicle when the width direction position of the following vehicle in the traveling lane in the time period after the time point when the right turn blinker is turned on moves to the left side of the width direction position of the following vehicle in the traveling lane in the time period before the time point when the right turn blinker is turned on.
(20) In the traveling control device of any one of the aspects (1) to (19), the processor may be configured to make the host vehicle decelerate and make the width direction position of the host vehicle in the traveling lane gradually move to the right side when the processor predicts that there is the possibility that the following vehicle overtakes the host vehicle from the left side of the host vehicle.
(21) Another aspect of the present disclosure is a traveling control method including: acquiring result of detection of a surrounding situation sensor detecting a surrounding situation of a host vehicle driving on the right side of a road, the surrounding situation including a following vehicle positioned within a certain distance behind the host vehicle; calculating a change in traveling behavior of the following vehicle in a time period before and after a time point when a right turn blinker of the host vehicle is turned on based on the result of detection; and predicting the traveling behavior of the following vehicle before the host vehicle turns right or while the host vehicle is turning right based on the change in the traveling behavior of the following vehicle in the time period before and after the time point when the right turn blinker of the host vehicle is turned on.
(22) Another aspect of the present disclosure is a non-transitory recording medium having recorded thereon a computer program for causing a processor to perform a process including: acquiring result of detection of a surrounding situation sensor detecting a surrounding situation of a host vehicle driving on the right side of a road, the surrounding situation including a following vehicle positioned within a certain distance behind the host vehicle; calculating a change in traveling behavior of the following vehicle in a time period before and after a time point when a right turn blinker of the host vehicle is turned on based on the result of detection; and predicting the traveling behavior of the following vehicle before the host vehicle turns right or while the host vehicle is turning right based on the change in the traveling behavior of the following vehicle in the time period before and after the time point when the right turn blinker of the host vehicle is turned on.

According to the present disclosure, it is possible to suitably control the traveling of the host vehicle in accordance with the behavior of the following vehicle.

### BRIEF DESCRIPTION OF DRAWINGS

FIG. 1 is a view showing one example of a host vehicle 1 to which a traveling control device 14 of a first embodiment is applied.

FIG. 2 is a view for explaining one example in which a prediction unit 3C predicts that a following vehicle FV is waiting for the host vehicle 1 to finish turning left and a control unit 3D makes the host vehicle 1 decelerate and makes the width direction position of the host vehicle 1 in the traveling lane LN gradually move to the left side.

FIG. 3 is a view for explaining one example in which the prediction unit 3C predicts that there is a possibility that the following vehicle FV slips through the left side of the host vehicle 1 and the control unit 3D makes the host vehicle 1 decelerate without making the width direction position of the host vehicle 1 in the traveling lane LN change.

FIG. 4 is a view for explaining another example in which the prediction unit 3C predicts that there is the possibility that the following vehicle FV slips through the left side of the host vehicle 1 and the control unit 3D makes the host vehicle 1 decelerate without making the width direction position of the host vehicle 1 in the traveling lane LN change.

FIG. 5 is a view for explaining one example in which the prediction unit 3C predicts that the following vehicle FV is waiting for the host vehicle 1 to finish turning left or there is the possibility that the following vehicle FV slips through the left side of the host vehicle 1 and the control unit 3D makes the host vehicle 1 decelerate without making the width direction position of the host vehicle 1 in the traveling lane LN change.

FIG. 6 is a view for explaining another example in which the prediction unit 3C predicts that the following vehicle FV is waiting for the host vehicle 1 to finish turning left or there is the possibility that the following vehicle FV slips through the left side of the host vehicle 1 and the control unit 3D makes the host vehicle 1 decelerate without making the width direction position of the host vehicle 1 in the traveling lane LN change.

FIG. 7 is a view for explaining still another example in which the prediction unit 3C predicts that the following vehicle FV is waiting for the host vehicle 1 to finish turning left or there is the possibility that the following vehicle FV slips through the left side of the host vehicle 1 and the control unit 3D makes the host vehicle 1 decelerate without making the width direction position of the host vehicle 1 in the traveling lane LN change.

FIG. 8 is a view for explaining one example in which the prediction unit 3C predicts that there is the possibility that the following vehicle FV overtakes the host vehicle 1 from the right side of the host vehicle 1 and the control unit 3D makes the host vehicle 1 decelerate and makes the width direction position of the host vehicle 1 in the traveling lane LN gradually move to the left side.

FIG. 9 is a view for explaining another example in which the prediction unit 3C predicts that there is the possibility that the following vehicle FV overtakes the host vehicle 1 from the right side of the host vehicle 1 and the control unit 3D makes the host vehicle 1 decelerate and makes the width direction position of the host vehicle 1 in the traveling lane LN gradually move to the left side.

FIG. 10 is a view for explaining still another example in which the prediction unit 3C predicts that there is the possibility that the following vehicle FV overtakes the host vehicle 1 from the right side of the host vehicle 1 and the control unit 3D makes the host vehicle 1 decelerate and makes the width direction position of the host vehicle 1 in the traveling lane LN gradually move to the left side.

FIG. 11 is a flowchart for explaining one example of a process performed by a processor 143 of the traveling control device 14 of the first embodiment when a left turn blinker 15D of the host vehicle 1 planning to turn left at an intersection IS is turned on.

### DESCRIPTION OF EMBODIMENTS

Below, referring to the drawings, embodiments of traveling control device, traveling control method, and non-transitory recording medium of the present disclosure will be explained.

### First Embodiment

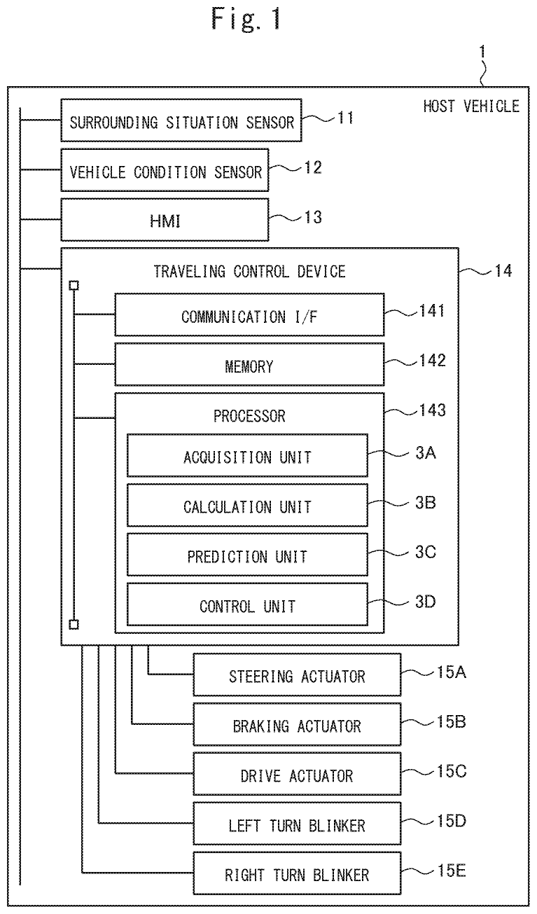

FIG. 1 is a view showing one example of a host vehicle 1 to which the traveling control device 14 of a first embodiment is applied.

In the example shown in FIG. 1, the host vehicle 1 is configured so as to travel on domestic roads with laws and regulations stating that vehicles must drive on the left-hand side of the roads. The host vehicle 1 is provided with surrounding situation sensor 11, vehicle condition sensor 12, HMI (human machine interface) 13, traveling control device 14, steering actuator 15A, braking actuator 15B, drive actuator 15C, left turn blinker 15D, and right turn blinker 15E.

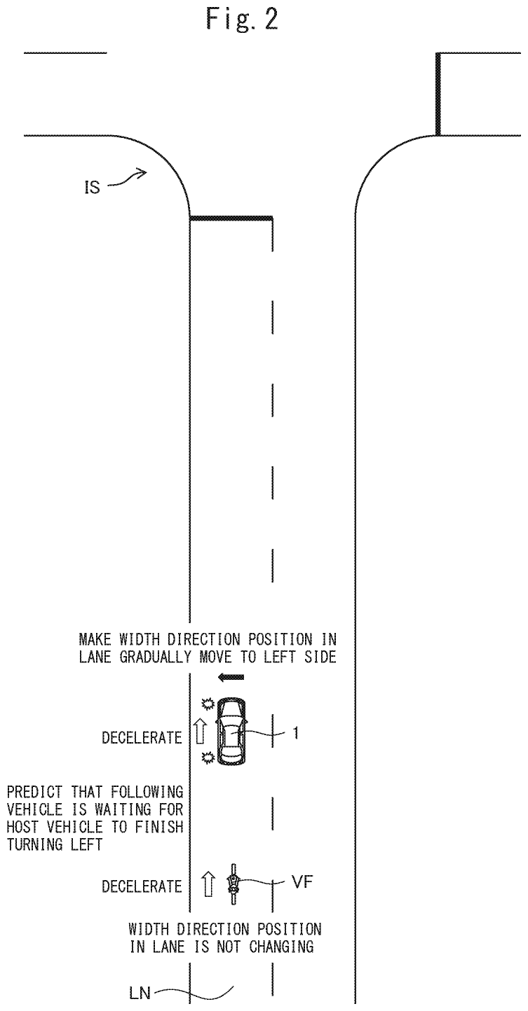

The surrounding situation sensor 11 detects a surrounding situation of the host vehicle 1 (for example, a following vehicle FV (see FIG. 2), structures in the surroundings of the host vehicle 1, etc.) and sends the result of detection to the traveling control device 14. In more detail, the surrounding situation sensor 11 detects the following vehicle FV positioned within a certain distance behind the host vehicle 1 and sends the result of detection to the traveling control device 14. The “certain distance” is, for example, a distance between the host vehicle 1 and following vehicle FV that allows the following vehicle FV to overtake the host vehicle 1 within several seconds when the host vehicle 1 starts to decelerate etc. Specifically, for example, the surrounding situation sensor 11 detects the relative position and the relative speed of the following vehicle FV with respect to the host vehicle 1 and sends the result of detection to the traveling control device 14. The surrounding situation sensor 11 includes, for example, camera shooting the rear and the like of the host vehicle 1, LiDAR (Light Detection And Ranging), radar, etc.

The vehicle condition sensor 12 detects condition of the host vehicle 1 and sends the result of detection to the traveling control device 14. The vehicle condition sensor 12, for example, includes speed sensor, acceleration sensor, etc.

The HMI 13 has the function of receiving various operations by a driver of the host vehicle 1, the function of outputting information indicating guidance, alert or the like by display, voice, etc. to the driver of the host vehicle 1, etc. and sends signals showing the operations of the driver of the host vehicle 1 to the traveling control device 14.

Specifically, for example, the HMI 13 receives the operation by the driver of the host vehicle 1 to turn on the left turn blinker 15D and sends the signal showing the operation to the traveling control device 14. Further, the HMI 13 receives the operation by the driver of the host vehicle 1 to turn on the right turn blinker 15E and sends the signal showing the operation to the traveling control device 14.

Furthermore, the HMI 13, for example, receives the operation by the driver of the host vehicle 1 to activate the braking actuator 15B to make the host vehicle 1 decelerate and sends the signal showing the operation to the traveling control device 14. Further, the HMI 13, for example, receives the operation by the driver of the host vehicle 1 to activate the steering actuator 15A to make the width (left-right direction in FIG. 2) position of the host vehicle 1 in the traveling lane LN (see FIG. 2) of the host vehicle 1 gradually move to the left side and sends the signal showing the operation to the traveling control device 14.

The traveling control device 14 performs control of traveling of the host vehicle 1 etc. In more detail, the traveling control device 14 is configured by a driving assistance ECU (electronic control unit). For example, the traveling control device 14 controls the steering actuator 15A, the braking actuator 15B, the drive actuator 15C, the left turn blinker 15D, and the right turn blinker 15E based on the information (data, signals) sent from the surrounding situation sensor 11, the vehicle condition sensor 12, and the HMI 13.

The traveling control device 14 is configured by a microcomputer provided with communication interface (I/F) 141, memory 142, and processor 143. The communication interface 141 has an interface circuit for connecting the traveling control device 14 to the surrounding situation sensor 11, the vehicle condition sensor 12, the HMI 13, the steering actuator 15A, the braking actuator 15B, the drive actuator 15C, the left turn blinker 15D, and the right turn blinker 15E. The memory 142 stores program used in a process performed by the processor 143 and various data. The processor 143 has the function as an acquisition unit 3A, the function as a calculation unit 3B, the function as a prediction unit 3C, and the function as a control unit 3D.

The acquisition unit 3A acquires the result of detection of the surrounding situation sensor 11, the result of detection of the vehicle condition sensor 12, the signals showing the operations by the driver of the host vehicle 1 received by the HMI 13, etc. In more detail, when the following vehicle FV (see FIG. 2) is positioned within the certain distance behind the host vehicle 1, the acquisition unit 3A acquires, as the result of detection of the surrounding situation sensor 11, the information showing the following vehicle FV (for example, the relative position and the relative speed of the following vehicle FV with respect to the host vehicle 1, etc.)

When the following vehicle FV is positioned within the certain distance behind the host vehicle 1 and when the HMI 13 receives the operation by the driver of the host vehicle 1 to turn on the left turn blinker 15D, the calculation unit 3B calculates a change in traveling behavior of the following vehicle FV in a time period before and after a time point when the left turn blinker 15D is turned on based on the result of detection of the surrounding situation sensor 11 acquired by the acquisition unit 3A (for example, the relative position, relative speed, etc. of the following vehicle FV with respect to the host vehicle 1).

The prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B.

The control unit 3D, for example, activates the steering actuator 15A, the braking actuator 15B, the drive actuator 15C, the left turn blinker 15D, and the right turn blinker 15E based on the information (data, signals) sent from the surrounding situation sensor 11, the vehicle condition sensor 12 and the HMI 13.

In more detail, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C.

FIG. 2 is a view for explaining one example in which the prediction unit 3C predicts that the following vehicle FV is waiting for the host vehicle 1 to finish turning left and the control unit 3D makes the host vehicle 1 decelerate and makes the width direction position of the host vehicle 1 in the traveling lane LN gradually move to the left side.

In the example shown in FIG. 2, the host vehicle 1 is planning to turn left at an intersection IS shown in FIG. 2 and the left turn blinker 15D is turned on. Further, the following vehicle FV is traveling within the certain distance behind the host vehicle 1, and the surrounding situation sensor 11 detects the following vehicle FV.

In the example shown in FIG. 2, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction position (position in left-right direction in FIG. 2) of the following vehicle FV in the traveling lane LN not changing in the time period before and after the time point when the left turn blinker 15D is turned on and the speed of the following vehicle FV in the time period after the time point when the left turn blinker 15D is turned on being lower than the speed of the following vehicle FV in the time period before the time point when the left turn blinker 15D is turned on.

In the example shown in FIG. 2, the calculation unit 3B calculates (estimates), as the change in the traveling behavior of the following vehicle FV, the following vehicle FV decelerating based on the result of detection of the surrounding situation sensor 11 (information showing that the distance between host vehicle 1 and following vehicle FV increases), but in another example, the calculation unit 3B may calculate, as the change in the traveling behavior of the following vehicle FV, the following vehicle FV decelerating based on the result of detection of the surrounding situation sensor 11 (relative speed of the following vehicle FV with respect to the host vehicle 1) and the result of detection of the vehicle condition sensor 12 (speed of the host vehicle 1).

In the example shown in FIG. 2, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN not changing in the time period before and after the time point when the left turn blinker 15D is turned on and the speed of the following vehicle FV in the time period after the time point when the left turn blinker 15D is turned on being lower than the speed of the following vehicle FV in the time period before the time point when the left turn blinker 15D is turned on). Specifically, the prediction unit 3C predicts that the following vehicle FV is waiting for the host vehicle 1 to finish turning left as the traveling behavior of the following vehicle FV before the host vehicle 1 turns left or while the host vehicle 1 is turning left.

In the example shown in FIG. 2, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, the following vehicle FV waiting for the host vehicle 1 to finish turning left). Specifically, the control unit 3D makes the host vehicle 1 decelerate and makes the width direction (left-right direction in FIG. 2) position of the host vehicle 1 in the traveling lane LN gradually move to the left side (left side in FIG. 2).

In more detail, in the example shown in FIG. 2, the control unit 3D makes the HMI 13 output guidance showing that it is necessary to make the host vehicle 1 decelerate and make the width direction position of the host vehicle 1 in the traveling lane LN gradually move to the left side.

When the HMI 13 receives the operation of the driver of the host vehicle 1 for making the host vehicle 1 decelerate and making the width direction position of the host vehicle 1 in the traveling lane LN gradually move to the left side after the HMI 13 outputs the guidance, the control unit 3D activates the steering actuator 15A and the braking actuator 15B in response to the operation of the driver of the host vehicle 1. As a result, before the host vehicle 1 turns left, the host vehicle 1 decelerates and the width direction position of the host vehicle 1 in the traveling lane LN gradually moves to the left side.

On the other hand, when the HMI 13 does not receive the operation of the driver of the host vehicle 1 for making the host vehicle 1 decelerate and making the width direction position of the host vehicle 1 in the traveling lane LN gradually move to the left side after the HMI 13 outputs the guidance, the control unit 3D makes the HMI 13 output the alert to prompt the driver of the host vehicle 1 to perform the operation.

That is, in the example shown in FIG. 2, the prediction unit 3C predicts the future behavior of the following vehicle FV (the following vehicle FV waiting for the host vehicle 1 to finish turning left), therefore the control unit 3D can suitably control the traveling of the host vehicle 1 without ending up delayed relative to the change in behavior of the following vehicle FV (specifically, can make the host vehicle 1 decelerate and make the width direction position of the host vehicle 1 in the traveling lane LN gradually move to the left side).

In the example shown in FIG. 2, the following vehicle FV is a motorcycle (two-wheeled vehicle), but in another example, the following vehicle FV may be a vehicle other than the motorcycle (two-wheeled vehicle) such as, for example, bicycle, kickboard, electric scooter, etc.

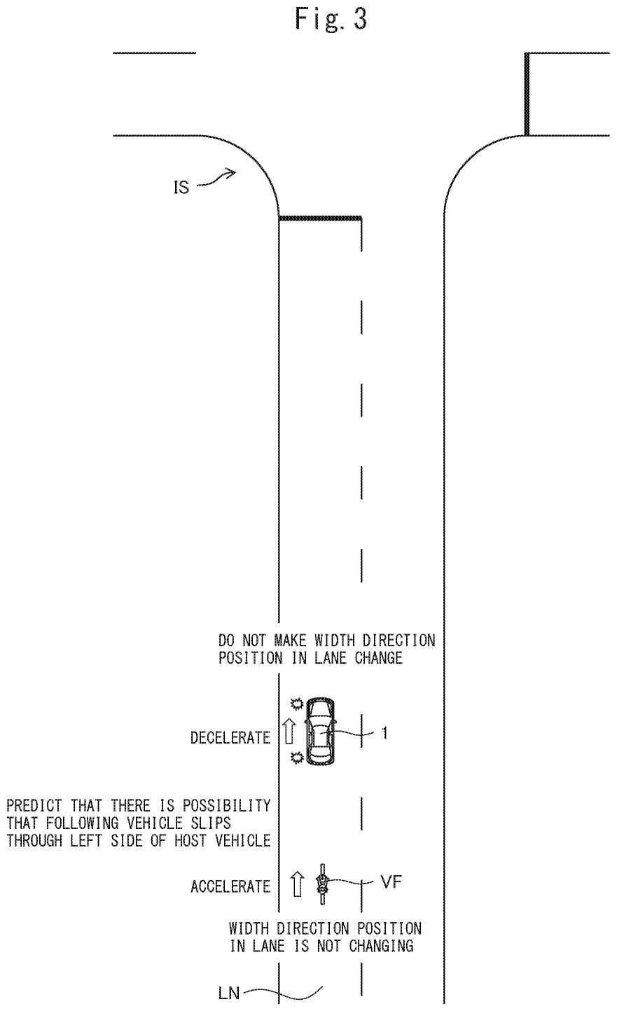

FIG. 3 is a view for explaining one example in which the prediction unit 3C predicts that there is a possibility that the following vehicle FV slips through the left side of the host vehicle 1 and the control unit 3D makes the host vehicle 1 decelerate without making the width direction position of the host vehicle 1 in the traveling lane LN change.

In the example shown in FIG. 3, the host vehicle 1 is planning to turn left at the intersection IS shown in FIG. 3 and the left turn blinker 15D is turned on. Further, the following vehicle FV is traveling within the certain distance behind the host vehicle 1, and the surrounding situation sensor 11 detects the following vehicle FV.

In the example shown in FIG. 3, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction position (position in left-right direction in FIG. 3) of the following vehicle FV in the traveling lane LN not changing in the time period before and after the time point when the left turn blinker 15D is turned on and the speed of the following vehicle FV in the time period after the time point when the left turn blinker 15D is turned on being higher than the speed of the following vehicle FV in the time period before the time point when the left turn blinker 15D is turned on.

In the example shown in FIG. 3, the calculation unit 3B calculates (estimates), as the change in the traveling behavior of the following vehicle FV, the following vehicle FV accelerating based on the result of detection of the surrounding situation sensor 11 (information showing that the distance between host vehicle 1 and following vehicle FV decreases), but in another example, the calculation unit 3B may calculate, as the change in the traveling behavior of the following vehicle FV, the following vehicle FV accelerating based on the result of detection of the surrounding situation sensor 11 (relative speed of the following vehicle FV with respect to the host vehicle 1) and the result of detection of the vehicle condition sensor 12 (speed of the host vehicle 1).

In the example shown in FIG. 3, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN not changing in the time period before and after the time point when the left turn blinker 15D is turned on and the speed of the following vehicle FV in the time period after the time point when the left turn blinker 15D is turned on being higher than the speed of the following vehicle FV in the time period before the time point when the left turn blinker 15D is turned on). Specifically, the prediction unit 3C predicts that there is the possibility that the following vehicle FV slips through the left side of the host vehicle 1 as the traveling behavior of the following vehicle FV before the host vehicle 1 turns left or while the host vehicle 1 is turning left.

In the example shown in FIG. 3, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, there is the possibility that the following vehicle FV slips through the left side of the host vehicle 1). Specifically, the control unit 3D makes the host vehicle 1 decelerate without making the width direction (left-right direction in FIG. 3) position of the host vehicle 1 in the traveling lane LN change (that is, allows the following vehicle FV to slip past).

In more detail, in the example shown in FIG. 3, the control unit 3D makes the HMI 13 output the guidance showing that it is necessary to make the host vehicle 1 decelerate without making the width direction position of the host vehicle 1 in the traveling lane LN change.

When the HMI 13 receives the operation of the driver of the host vehicle 1 for making the host vehicle 1 decelerate without making the width direction position of the host vehicle 1 in the traveling lane LN change after the HMI 13 outputs the guidance, the control unit 3D activates the steering actuator 15A and the braking actuator 15B in response to the operation of the driver of the host vehicle 1. As a result, before the host vehicle 1 turns left, the host vehicle 1 decelerates without the width direction position of the host vehicle 1 in the traveling lane LN changing.

On the other hand, when the HMI 13 does not receive the operation of the driver of the host vehicle 1 for making the host vehicle 1 decelerate without making the width direction position of the host vehicle 1 in the traveling lane LN change after the HMI 13 outputs the guidance, the control unit 3D makes the HMI 13 output the alert to prompt the driver of the host vehicle 1 to perform the operation.

That is, in the example shown in FIG. 3, the prediction unit 3C predicts the future behavior of the following vehicle FV (there is the possibility that the following vehicle FV slips through the left side of the host vehicle 1), therefore the control unit 3D can suitably control the traveling of the host vehicle 1 without ending up delayed relative to the change in behavior of the following vehicle FV (specifically, can make the host vehicle 1 decelerate without making the width direction position of the host vehicle 1 in the traveling lane LN change).

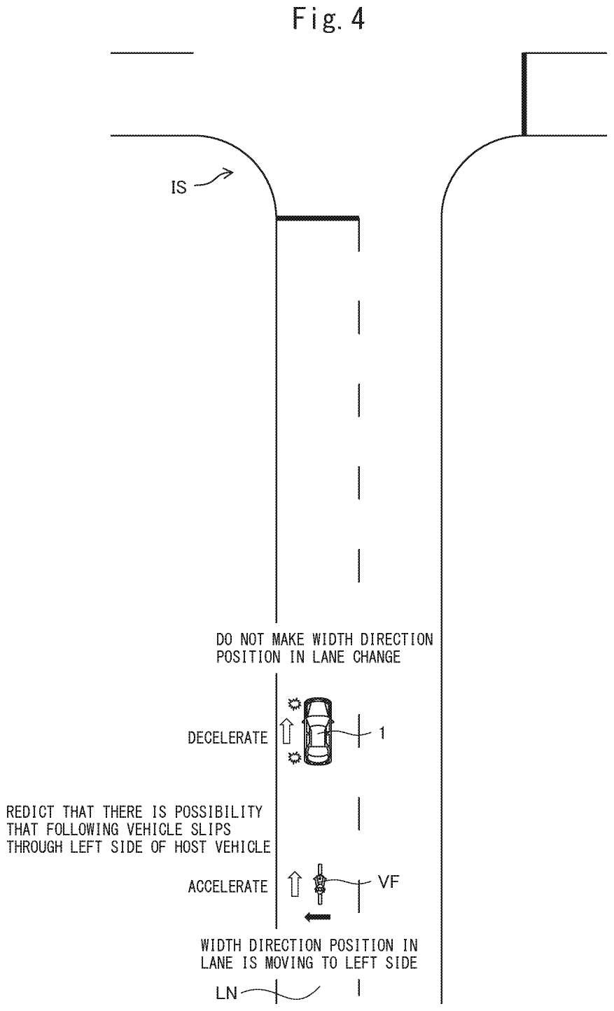

FIG. 4 is a view for explaining another example in which the prediction unit 3C predicts that there is the possibility that the following vehicle FV slips through the left side of the host vehicle 1 and the control unit 3D makes the host vehicle 1 decelerate without making the width direction position of the host vehicle 1 in the traveling lane LN change.

In the example shown in FIG. 4, the host vehicle 1 is planning to turn left at the intersection IS shown in FIG. 4 and the left turn blinker 15D is turned on. Further, the following vehicle FV is traveling within the certain distance behind the host vehicle 1, and the surrounding situation sensor 11 detects the following vehicle FV.

In the example shown in FIG. 4, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction (left-right direction in FIG. 4) position of the following vehicle in the traveling lane LN in the time period after the time point when the left turn blinker 15D is turned on moving to the left side (left side in FIG. 4) of the width direction position of the following vehicle FV in the traveling lane LN in the time period before the time point when the left turn blinker 15D is turned on and the speed of the following vehicle FV in the time period after the time point when the left turn blinker 15D is turned on being higher than the speed of the following vehicle FV in the time period before the time point when the left turn blinker 15D is turned on.

In the example shown in FIG. 4, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN in the time period after the time point when the left turn blinker 15D is turned on moving to the left side of the width direction position of the following vehicle FV in the traveling lane LN in the time period before the time point when the left turn blinker 15D is turned on and the speed of the following vehicle FV in the time period after the time point when the left turn blinker 15D is turned on being higher than the speed of the following vehicle FV in the time period before the time point when the left turn blinker 15D is turned on). Specifically, the prediction unit 3C predicts that there is the possibility that the following vehicle FV slips through the left side of the host vehicle 1 as the traveling behavior of the following vehicle FV before the host vehicle 1 turns left or while the host vehicle 1 is turning left.

In the example shown in FIG. 4, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, there is the possibility that the following vehicle FV slips through the left side of the host vehicle 1). Specifically, the control unit 3D makes the host vehicle 1 decelerate without making the width direction (left-right direction in FIG. 4) position of the host vehicle 1 in the traveling lane LN change (that is, allows the following vehicle FV to slip past).

In more detail, in the example shown in FIG. 4, the control unit 3D makes the HMI 13 output the guidance showing that it is necessary to make the host vehicle 1 decelerate without making the width direction position of the host vehicle 1 in the traveling lane LN change.

When the HMI 13 receives the operation of the driver of the host vehicle 1 for making the host vehicle 1 decelerate without making the width direction position of the host vehicle 1 in the traveling lane LN change after the HMI 13 outputs the guidance, the control unit 3D activates the steering actuator 15A and the braking actuator 15B in response to the operation of the driver of the host vehicle 1. As a result, before the host vehicle 1 turns left, the host vehicle 1 decelerates without the width direction position of the host vehicle 1 in the traveling lane LN changing.

On the other hand, when the HMI 13 does not receive the operation of the driver of the host vehicle 1 for making the host vehicle 1 decelerate without making the width direction position of the host vehicle 1 in the traveling lane LN change after the HMI 13 outputs the guidance, the control unit 3D makes the HMI 13 output the alert to prompt the driver of the host vehicle 1 to perform the operation.

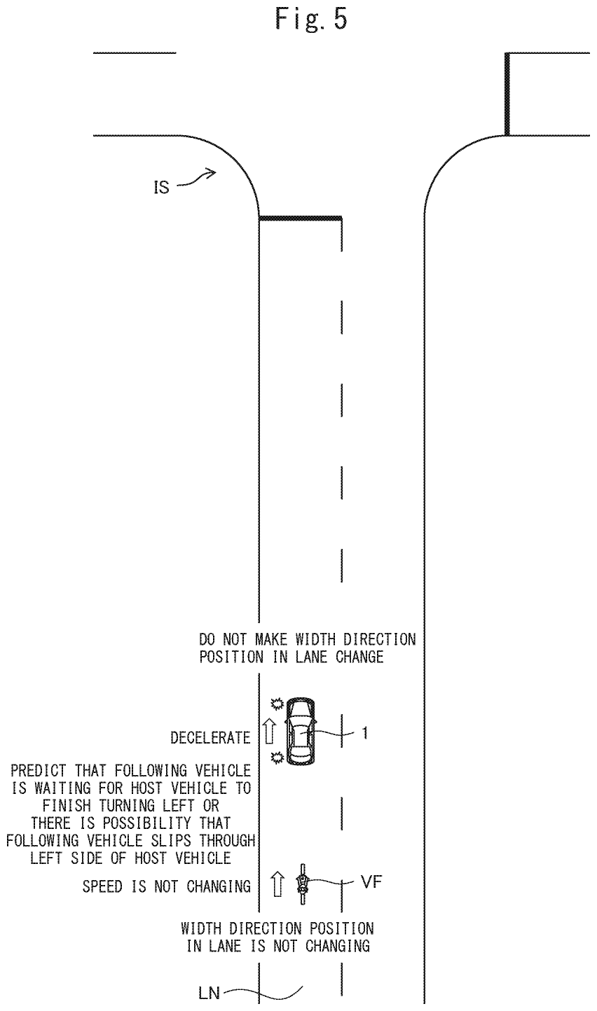

FIG. 5 is a view for explaining one example in which the prediction unit 3C predicts that the following vehicle FV is waiting for the host vehicle 1 to finish turning left or there is the possibility that the following vehicle FV slips through the left side of the host vehicle 1 and the control unit 3D makes the host vehicle 1 decelerate without making the width direction position of the host vehicle 1 in the traveling lane LN change.

In the example shown in FIG. 5, the host vehicle 1 is planning to turn left at the intersection IS shown in FIG. 5 and the left turn blinker 15D is turned on. Further, the following vehicle FV is traveling within the certain distance behind the host vehicle 1, and the surrounding situation sensor 11 detects the following vehicle FV.

In the example shown in FIG. 5, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction position (position in left-right direction in FIG. 5) of the following vehicle FV in the traveling lane LN in the time period before and after the time point when the left turn blinker 15D is turned on not changing and the speed of the following vehicle FV in the time period before and after the time point when the left turn blinker 15D is turned on not changing.

In the example shown in FIG. 5, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position (position in left-right direction in FIG. 5) of the following vehicle FV in the traveling lane LN in the time period before and after the time point when the left turn blinker 15D is turned on not changing and the speed of the following vehicle FV in the time period before and after the time point when the left turn blinker 15D is turned on not changing). Specifically, the prediction unit 3C predicts that the following vehicle FV waiting for the host vehicle 1 to finish turning left or there is the possibility that the following vehicle FV slips through the left side of the host vehicle 1 as the traveling behavior of the following vehicle FV before the host vehicle 1 turns left or while the host vehicle 1 is turning left.

In the example shown in FIG. 5, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, the following vehicle FV is waiting for the host vehicle 1 to finish turning left or there is the possibility that the following vehicle FV slips through the left side of the host vehicle 1). Specifically, the control unit 3D makes the host vehicle 1 decelerate without making the width direction (left-right direction in FIG. 5) position of the host vehicle 1 in the traveling lane LN change.

In more detail, in the example shown in FIG. 5, the control unit 3D makes the HMI 13 output the guidance showing that it is necessary to make the host vehicle 1 decelerate without making the width direction position of the host vehicle 1 in the traveling lane LN change.

When the HMI 13 receives the operation of the driver of the host vehicle 1 for making the host vehicle 1 decelerate without making the width direction position of the host vehicle 1 in the traveling lane LN change after the HMI 13 outputs the guidance, the control unit 3D activates the steering actuator 15A and the braking actuator 15B in response to the operation by the driver of the host vehicle 1. As a result, before the host vehicle 1 turns left, the host vehicle 1 decelerates without the width direction position of the host vehicle 1 in the traveling lane LN changing.

When the control unit 3D performs the control for making the host vehicle 1 decelerate without making the width direction position of the host vehicle 1 in the traveling lane LN change as shown in FIG. 5 and when the speed of the following vehicle FV in the time period after the time point when the control unit 3D performs the control for making the host vehicle 1 decelerate without making the width direction position of the host vehicle 1 in the traveling lane LN change is lower than the speed of the following vehicle FV in the time period before the time point when the control unit 3D performs the control for making the host vehicle 1 decelerate without making the width direction position of the host vehicle 1 in the traveling lane LN change as shown in FIG. 2, the prediction unit 3C predicts that the following vehicle FV is waiting for the host vehicle 1 to finish turning left.

The control unit 3D makes the host vehicle 1 decelerate and makes the width direction position of the host vehicle 1 in the traveling lane LN gradually move to the left side in the same way as the example shown in FIG. 2 based on the traveling behavior of the following vehicle FV before the host vehicle 1 turns left or while the host vehicle 1 is turning left predicted by the prediction unit 3C (that is, the following vehicle FV waiting for the host vehicle 1 to finish turning left).

On the other hand, when the control unit 3D performs the control for making the host vehicle 1 decelerate without making the width direction position of the host vehicle 1 in the traveling lane LN change as shown in FIG. 5 and when the speed of the following vehicle FV in the time period after the time point when the control unit 3D performs the control for making the host vehicle 1 decelerate without making the width direction position of the host vehicle 1 in the traveling lane LN change is not lower than the speed of the following vehicle FV in the time period before the time point when the control unit 3D performs the control for making the host vehicle 1 decelerate without making the width direction position of the host vehicle 1 in the traveling lane LN change (for example, when the following vehicle FV accelerates etc. as shown in FIG. 3), the prediction unit 3C predicts that there is the possibility that the following vehicle FV slips through the left side of the host vehicle 1.

The control unit 3D makes the host vehicle 1 decelerate without making the width direction position of the host vehicle 1 in the traveling lane LN change in the same way as the example shown in FIG. 3 (that is, allows the following vehicle FV to slip past) based on the traveling behavior of the following vehicle FV before the host vehicle 1 turns left or while the host vehicle 1 is turning left predicted by the prediction unit 3C (that is, there is the possibility that the following vehicle FV slips through the left side of the host vehicle 1).

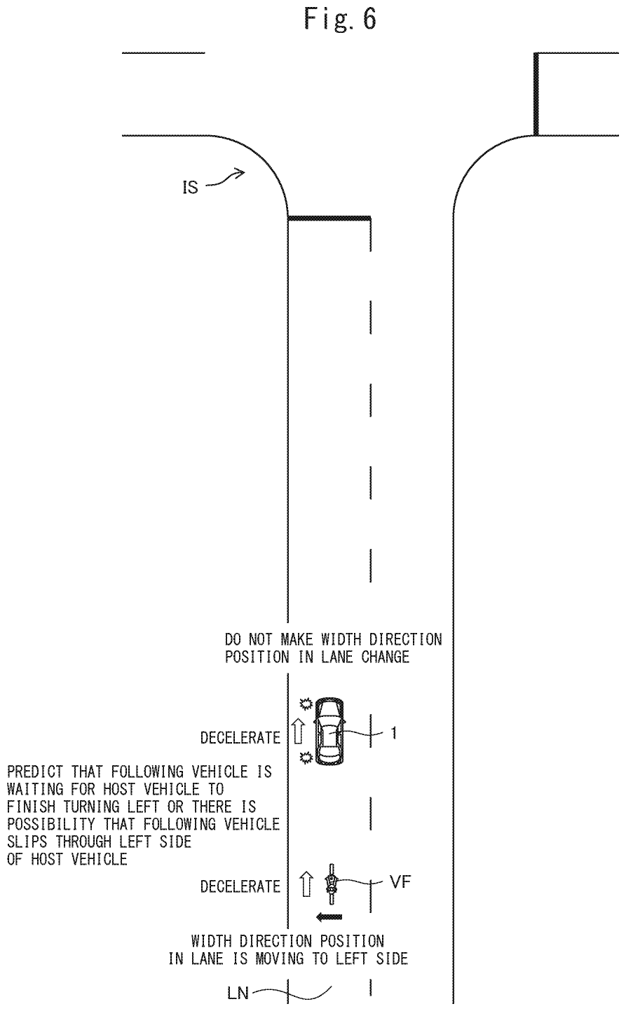

FIG. 6 is a view for explaining another example in which the prediction unit 3C predicts that the following vehicle FV is waiting for the host vehicle 1 to finish turning left or there is the possibility that the following vehicle FV slips through the left side of the host vehicle 1 and the control unit 3D makes the host vehicle 1 decelerate without making the width direction position of the host vehicle 1 in the traveling lane LN change.

In the example shown in FIG. 6, the host vehicle 1 is planning to turn left at the intersection IS shown in FIG. 6 and the left turn blinker 15D is turned on. Further, the following vehicle FV is traveling within the certain distance behind the host vehicle 1, and the surrounding situation sensor 11 detects the following vehicle FV.

In the example shown in FIG. 6, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction (left-right direction in FIG. 6) position of the following vehicle FV in the traveling lane LN in the time period after the time point when the left turn blinker 15D is turned on moving to the left side (left side in FIG. 6) of the width direction position of the following vehicle FV in the traveling lane LN in the time period before the time point when the left turn blinker 15D is turned on and the speed of the following vehicle FV in the time period after the time point when the left turn blinker 15D is turned on being lower than the speed of the following vehicle FV in the time period before the time point when the left turn blinker 15D is turned on.

In the example shown in FIG. 6, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN in the time period after the time point when the left turn blinker 15D is turned on moving to the left side of the width direction position of the following vehicle FV in the traveling lane LN in the time period before the time point when the left turn blinker 15D is turned on and the speed of the following vehicle FV in the time period after the time point when the left turn blinker 15D is turned on being lower than the speed of the following vehicle FV in the time period before the time point when the left turn blinker 15D is turned on). Specifically, the prediction unit 3C predicts that the following vehicle FV is waiting for the host vehicle 1 to finish turning left or there is the possibility that the following vehicle FV slips through the left side of the host vehicle 1 as the traveling behavior of the following vehicle FV before the host vehicle 1 turns left or while the host vehicle 1 is turning left.

In the example shown in FIG. 6, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, the following vehicle FV is waiting for the host vehicle 1 to finish turning left or there is the possibility that the following vehicle FV slips through the left side of the host vehicle 1). Specifically, the control unit 3D makes the host vehicle 1 decelerate without making the width direction (left-right direction in FIG. 6) position of the host vehicle 1 in the traveling lane LN change.

In more detail, in the example shown in FIG. 6, the control unit 3D makes the HMI 13 output the guidance showing that it is necessary to make the host vehicle 1 decelerate without making the width direction position of the host vehicle 1 in the traveling lane LN change.

When the HMI 13 receives the operation of the driver of the host vehicle 1 for making the host vehicle 1 decelerate without making the width direction position of the host vehicle 1 in the traveling lane LN change after the HMI 13 outputs the guidance, the control unit 3D activates the steering actuator 15A and the braking actuator 15B in response to the operation by the driver of the host vehicle 1. As a result, before the host vehicle 1 turns left, the host vehicle 1 decelerates without the width direction position of the host vehicle 1 in the traveling lane LN changing.

When the control unit 3D performs the control for making the host vehicle 1 decelerate without making the width direction position of the host vehicle 1 in the traveling lane LN change as shown in FIG. 6 and when the speed of the following vehicle FV in the time period after the time point when the control unit 3D performs the control for making the host vehicle 1 decelerate without making the width direction position of the host vehicle 1 in the traveling lane LN change is lower than the speed of the following vehicle FV in the time period before the time point when the control unit 3D performs the control for making the host vehicle 1 decelerate without making the width direction position of the host vehicle 1 in the traveling lane LN change as shown in FIG. 2, the prediction unit 3C predicts that the following vehicle FV is waiting for the host vehicle 1 to finish turning left.

The control unit 3D makes the host vehicle 1 decelerate and makes the width direction position of the host vehicle 1 in the traveling lane LN gradually move to the left side in the same way as shown in FIG. 2 based on the traveling behavior of the following vehicle FV before the host vehicle 1 turns left or while the host vehicle 1 is turning left predicted by the prediction unit 3C (that is, the following vehicle FV waiting for the host vehicle 1 to finish turning left).

On the other hand, when the control unit 3D performs the control for making the host vehicle 1 decelerate without making the width direction position of the host vehicle 1 in the traveling lane LN change as shown in FIG. 6 and when the speed of the following vehicle FV in the time period after the time point when the control unit 3D performs the control for making the host vehicle 1 decelerate without making the width direction position of the host vehicle 1 in the traveling lane LN change is not lower than the speed of the following vehicle FV in the time period before the time point when the control unit 3D performs the control for making the host vehicle 1 decelerate without making the width direction position of the host vehicle 1 in the traveling lane LN change (for example, when the following vehicle FV accelerates etc. as shown in FIG. 3), the prediction unit 3C predicts that there is the possibility that the following vehicle FV slips through the left side of the host vehicle 1.

The control unit 3D makes the host vehicle 1 decelerate without making the width direction position of the host vehicle 1 in the traveling lane LN change in the same way as the example shown in FIG. 3 (that is, allows the following vehicle FV to slip past) based on the traveling behavior of the following vehicle FV before the host vehicle 1 turns left or while the host vehicle 1 is turning left predicted by the prediction unit 3C (that is, there is the possibility that the following vehicle FV slips through the left side of the host vehicle 1).

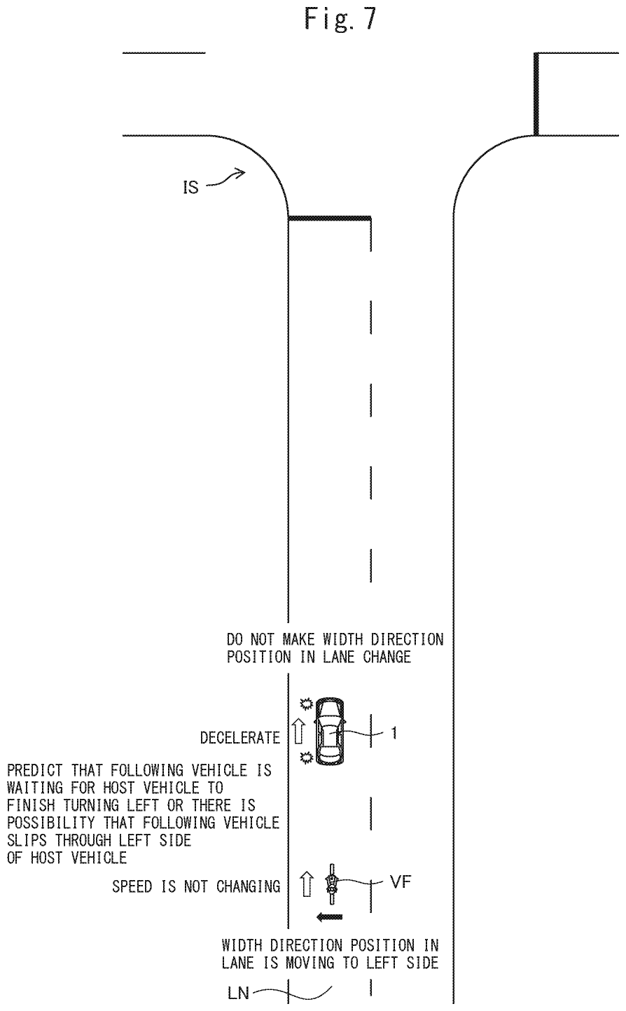

FIG. 7 is a view for explaining still another example in which the prediction unit 3C predicts that the following vehicle FV is waiting for the host vehicle 1 to finish turning left or there is the possibility that the following vehicle FV slips through the left side of the host vehicle 1 and the control unit 3D makes the host vehicle 1 decelerate without making the width direction position of the host vehicle 1 in the traveling lane LN change.

In the example shown in FIG. 7, the host vehicle 1 is planning to turn left at the intersection IS shown in FIG. 7 and the left turn blinker 15D is turned on. Further, the following vehicle FV is traveling within the certain distance behind the host vehicle 1, and the surrounding situation sensor 11 detects the following vehicle FV.

In the example shown in FIG. 7, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction (left-right direction in FIG. 7) position of the following vehicle FV in the traveling lane LN in the time period after the time point when the left turn blinker 15D is turned on moving to the left side (left side of FIG. 7) of the width direction position of the following vehicle FV in the traveling lane LN in the time period before the time point when the left turn blinker 15D is turned on and the speed of the following vehicle FV in the time period before and after the time point when the left turn blinker 15D is turned on not changing.

In the example shown in FIG. 7, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN in the time period after the time point when the left turn blinker 15D is turned on moving to the left side of the width direction position of the following vehicle FV in the traveling lane LN in the time period before the time point when the left turn blinker 15D is turned on and the speed of the following vehicle FV in the time period before and after the time point when the left turn blinker 15D is turned on not changing). Specifically, the prediction unit 3C predicts that the following vehicle FV is waiting for the host vehicle 1 to finish turning left or there is the possibility that the following vehicle FV slips through the left side of the host vehicle 1 as the traveling behavior of the following vehicle FV before the host vehicle 1 turns left or while the host vehicle 1 is turning left.

In the example shown in FIG. 7, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, the following vehicle FV is waiting for the host vehicle 1 to finish turning left or there is the possibility that the following vehicle FV slips through the left side of the host vehicle 1). Specifically, the control unit 3D makes the host vehicle 1 decelerate without making the width direction (left-right direction in FIG. 7) position of the host vehicle 1 in the traveling lane LN change.

In more detail, in the example shown in FIG. 7, the control unit 3D makes the HMI 13 output the guidance showing that it is necessary to make the host vehicle 1 decelerate without making the width direction position of the host vehicle 1 in the traveling lane LN change.

When the HMI 13 receives the operation of the driver of the host vehicle 1 for making the host vehicle 1 decelerate without making the width direction position of the host vehicle 1 in the traveling lane LN change after the HMI 13 outputs the guidance, control unit 3D activates the steering actuator 15A and the braking actuator 15B in response to the operation by the driver of the host vehicle 1. As a result, before the host vehicle 1 turns left, the host vehicle 1 decelerates without the width direction position of the host vehicle 1 in the traveling lane LN changing.

When the control unit 3D performs the control for making the host vehicle 1 decelerate without making the width direction position of the host vehicle 1 in the traveling lane LN change as shown in FIG. 7 and when the speed of the following vehicle FV in the time period after the time point when the control unit 3D performs the control for making the host vehicle 1 decelerate without making the width direction position of the host vehicle 1 in the traveling lane LN change is lower than the speed of the following vehicle FV in the time period before the time point when the control unit 3D performs the control for making the host vehicle 1 decelerate without making the width direction position of the host vehicle 1 in the traveling lane LN change as shown in FIG. 2, the prediction unit 3C predicts that the following vehicle FV is waiting for the host vehicle 1 to finish turning left.

The control unit 3D makes the host vehicle 1 decelerate and makes the width direction position of the host vehicle 1 in the traveling lane LN gradually move to the left side in the same way as shown in FIG. 2 based on the traveling behavior of the following vehicle FV before the host vehicle 1 turns left or while the host vehicle 1 is turning left predicted by the prediction unit 3C (that is, the following vehicle FV waiting for the host vehicle 1 to finish turning left).

On the other hand, when the control unit 3D performs the control for making the host vehicle 1 decelerate without making the width direction position of the host vehicle 1 in the traveling lane LN change as shown in FIG. 7 and when the speed of the following vehicle FV in the time period after the time point when the control unit 3D performs the control for making the host vehicle 1 decelerate without making the width direction position of the host vehicle 1 in the traveling lane LN change is not lower than the speed of the following vehicle FV in the time period before the time point when the control unit 3D performs the control for making the host vehicle 1 decelerate without making the width direction position of the host vehicle 1 in the traveling lane LN change (for example, when the following vehicle FV accelerates etc. as shown in FIG. 3), the prediction unit 3C predicts that there is the possibility that the following vehicle FV slips through the left side of the host vehicle 1.

The control unit 3D makes the host vehicle 1 decelerate without making the width direction position of the host vehicle 1 in the traveling lane LN change in the same way as the example shown in FIG. 3 (that is, allows the following vehicle FV to slip past) based on the traveling behavior of the following vehicle FV before the host vehicle 1 turns left or while the host vehicle 1 is turning left predicted by the prediction unit 3C (that is, there is the possibility that the following vehicle FV slips through the left side of the host vehicle 1).

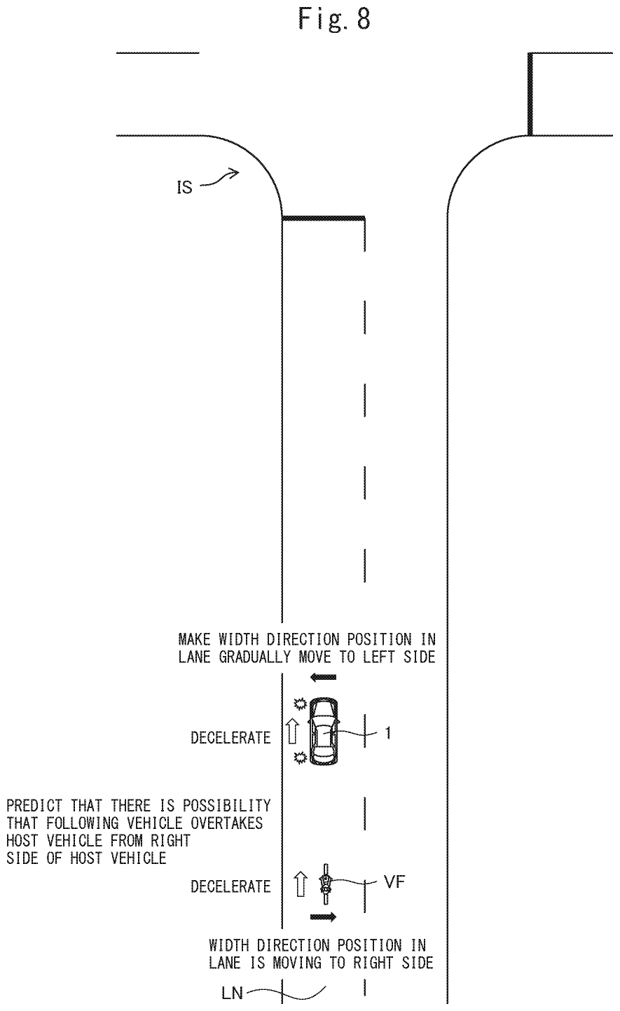

FIG. 8 is a view for explaining one example in which the prediction unit 3C predicts that there is the possibility that the following vehicle FV overtakes the host vehicle 1 from the right side of the host vehicle 1 and the control unit 3D makes the host vehicle 1 decelerate and makes the width direction position of the host vehicle 1 in the traveling lane LN gradually move to the left side.

In the example shown in FIG. 8, the host vehicle 1 is planning to turn left at the intersection IS shown in FIG. 8 and the left turn blinker 15D is turned on. Further, the following vehicle FV is traveling within the certain distance behind the host vehicle 1, and the surrounding situation sensor 11 detects the following vehicle FV.

In the example shown in FIG. 8, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction (left-right direction in FIG. 8) position of the following vehicle FV in the traveling lane LN in the time period after the time point when the left turn blinker 15D is turned on moving to the right side (right side in FIG. 8) of the width direction position of the following vehicle FV in the traveling lane LN in the time period before the time point when the left turn blinker 15D is turned on and the speed of the following vehicle FV in the time period after the time point when the left turn blinker 15D is turned on being lower than the speed of the following vehicle FV in the time period before the time point when the left turn blinker 15D is turned on.

In the example shown in FIG. 8, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN in the time period after the time point when the left turn blinker 15D is turned on moving to the right side of the width direction position of the following vehicle FV in the traveling lane LN in the time period before the time point when the left turn blinker 15D is turned on and the speed of the following vehicle FV in the time period after the time point when the left turn blinker 15D is turned on being lower than the speed of the following vehicle FV in the time period before the time point when the left turn blinker 15D is turned on). Specifically, the prediction unit 3C predicts that there is the possibility that the following vehicle FV overtakes the host vehicle 1 from the right side (right side in FIG. 8) of the host vehicle 1 as the traveling behavior of the following vehicle FV before the host vehicle 1 turns left or while the host vehicle 1 is turning left.

In the example shown in FIG. 8, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, there is the possibility that the following vehicle FV overtakes the host vehicle 1 from the right side (right side in FIG. 8) of the host vehicle 1). Specifically, the control unit 3D makes the host vehicle 1 decelerate and makes the width direction (left-right direction in FIG. 8) position of the host vehicle 1 in the traveling lane LN gradually move to the left side (left side in FIG. 8).

In more detail, in the example shown in FIG. 8, the control unit 3D makes the HMI 13 output the guidance showing that it is necessary to make the host vehicle 1 decelerate and make the width direction position of the host vehicle 1 in the traveling lane LN gradually move to the left side.

When the HMI 13 receives the operation of the driver of the host vehicle 1 for making the host vehicle 1 decelerate and making the width direction position of the host vehicle 1 in the traveling lane LN gradually move to the left side after the HMI 13 outputs the guidance, the control unit 3D activates the steering actuator 15A and the braking actuator 15B in response to the operation by the driver of the host vehicle 1. As a result, before the host vehicle 1 turns left, the host vehicle 1 decelerates and the width direction position of the host vehicle 1 in the traveling lane LN gradually moves to the left side.

On the other hand, when the HMI 13 does not receive the operation of the driver of the host vehicle 1 for making the host vehicle 1 decelerate and making the width direction position of the host vehicle 1 in the traveling lane LN gradually move to the left side after the HMI 13 outputs the guidance, the control unit 3D makes the HMI 13 output the alert to prompt the driver of the host vehicle 1 to perform the operation.

That is, in the example shown in FIG. 8, the prediction unit 3C predicts the future behavior of the following vehicle FV (there is the possibility that the following vehicle FV overtakes the host vehicle 1 from the right side (right side in FIG. 8) of the host vehicle 1), therefore the control unit 3D can suitably control the traveling of the host vehicle 1 without ending up delayed relative to the change in behavior of the following vehicle FV (specifically, can make the host vehicle 1 decelerate and make the width direction position of the host vehicle 1 in the traveling lane LN gradually move to the left side).

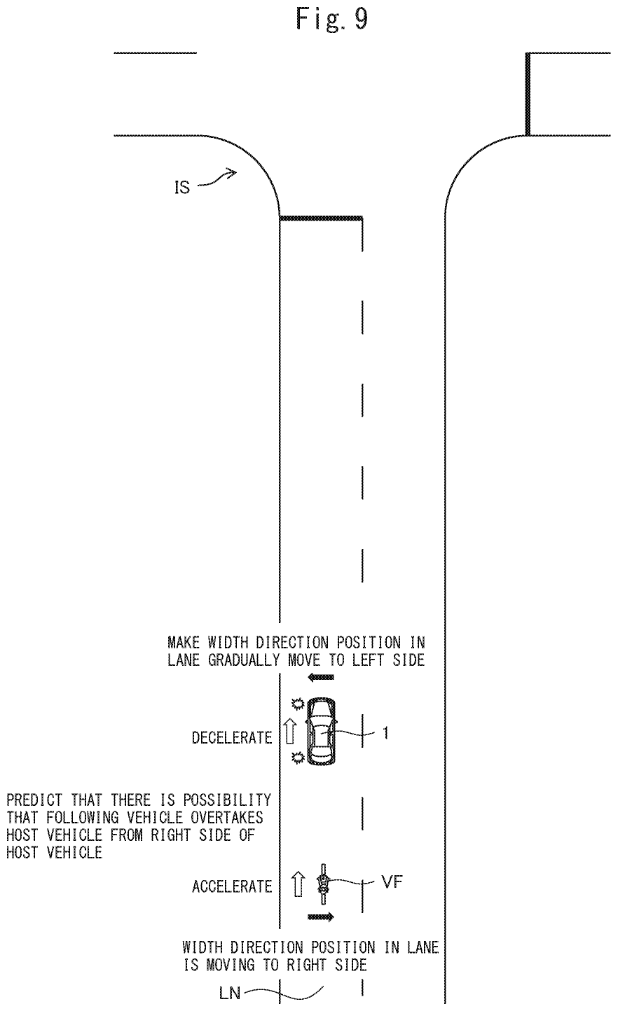

FIG. 9 is a view for explaining another example in which the prediction unit 3C predicts that there is the possibility that the following vehicle FV overtakes the host vehicle 1 from the right side of the host vehicle 1 and the control unit 3D makes the host vehicle 1 decelerate and makes the width direction position of the host vehicle 1 in the traveling lane LN gradually move to the left side.

In the example shown in FIG. 9, the host vehicle 1 is planning to turn left at the intersection IS shown in FIG. 9 and the left turn blinker 15D is turned on. Further, the following vehicle FV is traveling within the certain distance behind the host vehicle 1, and the surrounding situation sensor 11 detects the following vehicle FV.

In the example shown in FIG. 9, the calculation unit 3B calculates the change in the traveling behavior of the following vehicle FV in the time period before and after the time point when the left turn blinker 15D is turned on based on the result of detection of the surrounding situation sensor 11 in the time period before and after the time point when the left turn blinker 15D is turned on. Specifically, the calculation unit 3B calculates, as the change in the traveling behavior of the following vehicle FV, the width direction (left-right direction in FIG. 9) position of the following vehicle FV in the traveling lane LN in the time period after the time point when the left turn blinker 15D is turned on moving to the right side (right side in FIG. 9) of the width direction position of the following vehicle FV in the traveling lane LN in the time period before the time point when the left turn blinker 15D is turned on and the speed of the following vehicle FV in the time period after the time point when the left turn blinker 15D is turned on being higher than the speed of the following vehicle FV in the time period before the time point when the left turn blinker 15D is turned on.

In the example shown in FIG. 9, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN in the time period after the time point when the left turn blinker 15D is turned on moving to the right side of the width direction position of the following vehicle FV in the traveling lane LN in the time period before the time point when the left turn blinker 15D is turned on and the speed of the following vehicle FV in the time period after the time point when the left turn blinker 15D is turned on being higher than the speed of the following vehicle FV in the time period before the time point when the left turn blinker 15D is turned on). Specifically, the prediction unit 3C predicts that there is the possibility that the following vehicle FV overtakes the host vehicle 1 from the right side (right side in FIG. 9) of the host vehicle 1 as the traveling behavior of the following vehicle FV before the host vehicle 1 turns left or while the host vehicle 1 is turning left.

In the example shown in FIG. 9, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, there is the possibility that the following vehicle FV overtakes the host vehicle 1 from the right side (right side in FIG. 9) of the host vehicle 1). Specifically, the control unit 3D makes the host vehicle 1 decelerate and makes the width direction (left-right direction in FIG. 9) position of the host vehicle 1 in the traveling lane LN gradually move to the left side (left side in FIG. 9).

In more detail, in the example shown in FIG. 9, the control unit 3D makes the HMI 13 output the guidance showing that it is necessary to make the host vehicle 1 decelerate and make the width direction position of the host vehicle 1 in the traveling lane LN gradually move to the left side.

When the HMI 13 receives the operation of the driver of the host vehicle 1 for making the host vehicle 1 decelerate and making the width direction position of the host vehicle 1 in the traveling lane LN gradually move to the left side after the HMI 13 outputs the guidance, the control unit 3D activates the steering actuator 15A and the braking actuator 15B in response to the operation of the driver of the host vehicle 1. As a result, before the host vehicle 1 turns left, the host vehicle 1 decelerates and the width direction position of the host vehicle 1 in the traveling lane LN gradually moves to the left side.

On the other hand, when the HMI 13 does not receive the operation of the driver of the host vehicle 1 for making the host vehicle 1 decelerate and making the width direction position of the host vehicle 1 in the traveling lane LN gradually move to the left side after the HMI 13 outputs the guidance, the control unit 3D makes the HMI 13 output the alert to prompt the driver of the host vehicle 1 to perform the operation.

That is, in the example shown in FIG. 9, the prediction unit 3C predicts the future behavior of the following vehicle FV (there is the possibility that the following vehicle FV overtakes the host vehicle 1 from the right side (right side in FIG. 9) of the host vehicle 1), therefore the control unit 3D can suitably control the traveling of the host vehicle 1 without ending up delayed relative to the change in behavior of the following vehicle FV (specifically, can make the host vehicle 1 decelerate and make the width direction position of the host vehicle 1 in the traveling lane LN gradually move to the left side).

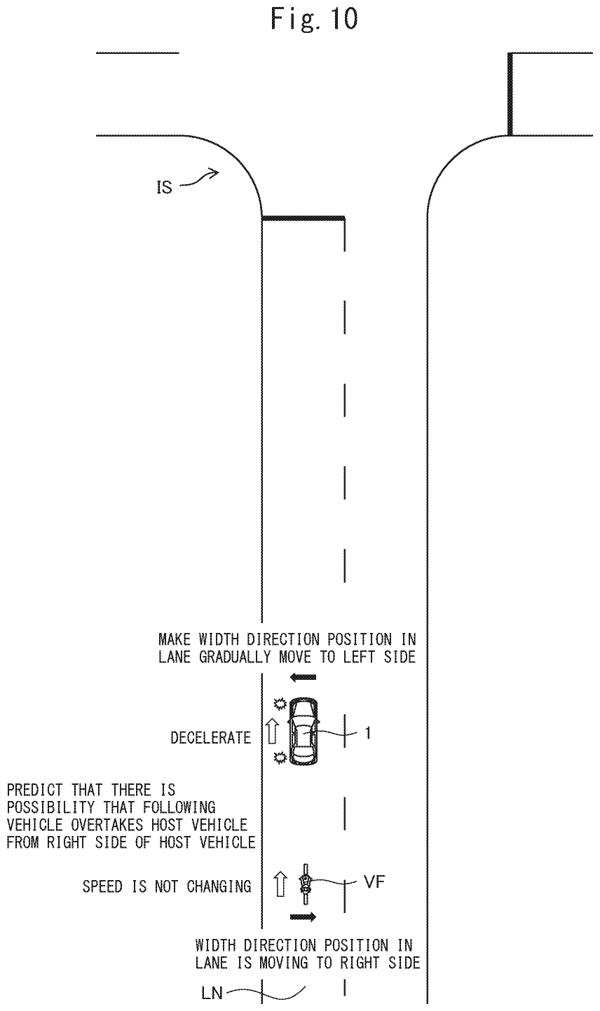

FIG. 10 is a view for explaining still another example in which the prediction unit 3C predicts that there is the possibility that the following vehicle FV overtakes the host vehicle 1 from the right side of the host vehicle 1 and the control unit 3D makes the host vehicle 1 decelerate and makes the width direction position of the host vehicle 1 in the traveling lane LN gradually move to the left side.

In the example shown in FIG. 10, the host vehicle 1 is planning to turn left at the intersection IS shown in FIG. 10 and the left turn blinker 15D is turned on. Further, the following vehicle FV is traveling within the certain distance behind the host vehicle 1, and the surrounding situation sensor 11 detects the following vehicle FV.

In the example shown in FIG. 10, the calculation unit 3B calculates the change in the traveling behavior of the following vehicle FV in the time period before and after the time point when the left turn blinker 15D is turned on based the result of detection of the surrounding situation sensor 11 in the time period before and after the time point when the left turn blinker 15D is turned on. Specifically, the calculation unit 3B calculates, as the change in the traveling behavior of the following vehicle FV, the width direction (left-right direction in FIG. 10) position of the following vehicle FV in the traveling lane LN in the time period after the time point when the left turn blinker 15D is turned on moving to the right side (right side in FIG. 10) of the width direction position of the following vehicle FV in the traveling lane LN in the time period before the time point when the left turn blinker 15D is turned on and the speed of the following vehicle FV in the time period before and after the time point when the left turn blinker 15D is turned on not changing.

In the example shown in FIG. 10, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated by the calculation unit 3B (that is, the width direction position of the following vehicle FV in the traveling lane LN in the time period after the time point when the left turn blinker 15D is turned on moving to the right side of the width direction position of the following vehicle FV in the traveling lane LN in the time period before the time point when the left turn blinker 15D is turned on and the speed of the following vehicle FV in the time period before and after the time point when the left turn blinker 15D is turned on not changing. Specifically, the prediction unit 3C predicts that there is the possibility that the following vehicle FV overtakes the host vehicle 1 from the right side (right side in FIG. 10) of the host vehicle 1 as the traveling behavior of the following vehicle FV before the host vehicle 1 turns left or while the host vehicle 1 is turning left.

In the example shown in FIG. 10, the control unit 3D controls the traveling of the host vehicle 1 before the host vehicle 1 turns left based on the traveling behavior of the following vehicle FV before the host vehicle 1 turns left or while the host vehicle 1 is turning left predicted by the prediction unit 3C (that is, there is the possibility that the following vehicle FV overtakes the host vehicle 1 from the right side (right side in FIG. 10) of the host vehicle 1. Specifically, the control unit 3D makes the host vehicle 1 decelerate and makes the width direction (left-right direction in FIG. 10) position of the host vehicle 1 in the traveling lane LN gradually move to the left side (left side in FIG. 10).

In more detail, in the example shown in FIG. 10, the control unit 3D makes the HMI 13 output the guidance showing that it is necessary to make the host vehicle 1 decelerate and make the width direction position of the host vehicle 1 in the traveling lane LN gradually move to the left side.

When the HMI 13 receives the operation of the driver of the host vehicle 1 for making the host vehicle 1 decelerate and making the width direction position of the host vehicle 1 in the traveling lane LN gradually move to the left side after the HMI 13 outputs the guidance, the control unit 3D activates the steering actuator 15A and the braking actuator 15B in response to the operation of the driver of the host vehicle 1. As a result, before the host vehicle 1 turns left, the host vehicle 1 decelerates while the width direction position of the host vehicle 1 in the traveling lane LN gradually moves to the left side.

On the other hand, when the HMI 13 does not receive the operation of the driver of the host vehicle 1 for making the host vehicle 1 decelerate and making the width direction position of the host vehicle 1 in the traveling lane LN gradually move to the left side after the HMI 13 outputs the guidance, the control unit 3D makes the HMI 13 output the alert to prompt the driver of the host vehicle 1 to perform the operation.

That is, in the example shown in FIG. 10, the prediction unit 3C predicts the future behavior of the following vehicle FV (there is the possibility that the following vehicle FV overtakes the host vehicle 1 from the right side (right side of FIG. 10) of the host vehicle 1), therefore the control unit 3D can suitably control the traveling of the host vehicle 1 without ending up delayed relative to the change in behavior of the following vehicle FV (specifically, can make the host vehicle 1 decelerate and make the width direction position of the host vehicle 1 in the traveling lane LN gradually move to the left side).

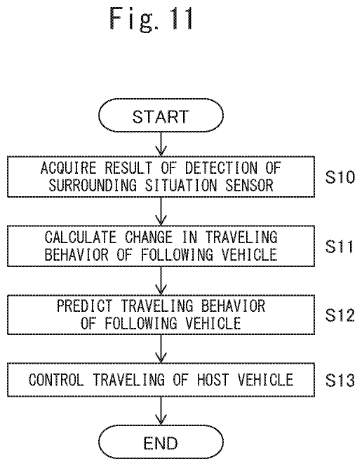

FIG. 11 is a flowchart for explaining one example of the process performed by the processor 143 of the traveling control device 14 of the first embodiment when the left turn blinker 15D of the host vehicle 1 planning to turn left at the intersection IS is turned on.

In the example shown in FIG. 11, at step S10, the acquisition unit 3A acquires the result of detection of the surrounding situation sensor 11.

At step S11, the calculation unit 3B calculates the change in the traveling behavior of the following vehicle FV in the time period before and after the time point when the left turn blinker 15D of the host vehicle 1 is turned on based on the result of detection of the surrounding situation sensor 11 acquired at step S10.

At step S12, the prediction unit 3C predicts the traveling behavior of the following vehicle FV before the host vehicle 1 turns left or while the host vehicle 1 is turning left based on the change in the traveling behavior of the following vehicle FV in the time period before and after the time point when the left turn blinker 15D is turned on calculated at step S11.

At step S13, the control unit 3D controls the traveling of the host vehicle 1 before the host vehicle 1 turns left based on the traveling behavior of the following vehicle FV before the host vehicle 1 turns left or while the host vehicle 1 is turning left predicted at step S12.

### Second Embodiment

The host vehicle 1 to which the traveling control device 14 of a second embodiment is applied is configured in the same way as the host vehicle 1 to which the traveling control device 14 of the above-mentioned first embodiment is applied except for the points mentioned later.

As explained above, in the example shown in FIG. 2 of the host vehicle 1 to which the traveling control device 14 of the first embodiment is applied, the control unit 3D makes the HMI 13 output the guidance showing that it is necessary to make the host vehicle 1 decelerate and make the width direction position of the host vehicle 1 in the traveling lane LN gradually move to the left side and when the HMI 13 receives the operation of the driver of the host vehicle 1 for making the host vehicle 1 decelerate and making the width direction position of the host vehicle 1 in the traveling lane LN gradually move to the left side after the HMI 13 outputs the guidance, the control unit 3D activates the steering actuator 15A and the braking actuator 15B in response to the operation of the driver of the host vehicle 1 and as a result, before the host vehicle 1 turns left, the host vehicle 1 decelerates and the width direction position of the host vehicle 1 in the traveling lane LN gradually moves to the left side.

On the other hand, in the example shown in FIG. 2 of the host vehicle 1 to which the traveling control device 14 of the second embodiment is applied, when the HMI 13 does not receive the operation of the driver of the host vehicle 1 for making the host vehicle 1 decelerate and making the width direction position of the host vehicle 1 in the traveling lane LN gradually move to the left side, the control unit 3D activates the steering actuator 15A and the braking actuator 15B so that the host vehicle 1 decelerates and the width direction position of the host vehicle 1 in the traveling lane LN gradually moves to the left side without need for the HMI 13 to receive the operation of the driver of the host vehicle 1.

### Third Embodiment

The host vehicle 1 to which the traveling control device 14 of a third embodiment is applied is configured in the same way as the host vehicle 1 to which the traveling control device 14 of the above-mentioned first embodiment is applied except for the points mentioned later.

In the example shown in FIG. 2 of the host vehicle 1 to which the traveling control device 14 of the third embodiment is applied, in the same way as the example shown in FIG. 2 of the host vehicle 1 to which the traveling control device 14 of the first embodiment is applied, the control unit 3D makes the HMI 13 output the guidance showing that it is necessary to make the host vehicle 1 decelerate and make the width direction position of the host vehicle 1 in the traveling lane LN gradually move to the left side and when the HMI 13 receives the operation of the driver of the host vehicle 1 for making the host vehicle 1 decelerate and making the width direction position of the host vehicle 1 in the traveling lane LN gradually move to the left side after the HMI 13 outputs the guidance, the control unit 3D activates the steering actuator 15A and the braking actuator 15B in response to the operation of the driver of the host vehicle 1 and as a result, before the host vehicle 1 turns left, the host vehicle 1 decelerates and the width direction position of the host vehicle 1 in the traveling lane LN gradually moves to the left side.

On the other hand, in the example shown in FIG. 2 of the host vehicle 1 to which the traveling control device 14 of the third embodiment is applied, unlike the example shown in FIG. 2 of the host vehicle 1 to which the traveling control device 14 of the first embodiment is applied, when the HMI 13 does not receive the operation of the driver of the host vehicle 1 for making the host vehicle 1 decelerate and making the width direction position of the host vehicle 1 in the traveling lane LN gradually move to the left side after the HMI 13 outputs the guidance, the control unit 3D may not make the HMI 13 output the alert to prompt the driver of the host vehicle 1 to perform the operation.

### Fourth Embodiment

The host vehicle 1 to which the traveling control device 14 of a fourth embodiment is applied is configured in the same way as the host vehicle 1 to which the traveling control device 14 of the above-mentioned first embodiment is applied except for the points mentioned later.

As explained above, in the example of the host vehicle 1 to which the traveling control device 14 of the first embodiment is applied (example shown in FIG. 1), the traveling control device 14 is configured by a driving assistance ECU.

On the other hand, in one example of the host vehicle 1 to which the traveling control device 14 of the fourth embodiment is applied, the traveling control device 14 is configured by an autonomous driving ECU.

In the example shown in FIG. 2 of the host vehicle 1 to which the traveling control device 14 of the fourth embodiment is applied, the calculation unit 3B calculates the width direction position (position in left-right direction in FIG. 2) of the following vehicle FV in the traveling lane LN not changing in the time period before and after the time point when the left turn blinker 15D is turned on and the speed of the following vehicle FV in the time period after the time point when the left turn blinker 15D is turned on being lower than the speed of the following vehicle FV in the time period before the time point when the left turn blinker 15D is turned on, when the prediction unit 3C predicts that the following vehicle FV is waiting for the host vehicle 1 to finish turning left, the traveling control device 14 (autonomous driving ECU) generates a traveling plan of the host vehicle 1 making the host vehicle 1 decelerate and making the width direction (left-right direction in FIG. 2) position of the host vehicle 1 in the traveling lane LN gradually move to the left side (left side in FIG. 2), and the control unit 3D activates the steering actuator 15A, the braking actuator 15B, and the drive actuator 15C based on that traveling plan.

### Fifth Embodiment

The host vehicle 1 to which the traveling control device 14 of a fifth embodiment is applied is configured in the same way as the host vehicle 1 to which the traveling control device 14 of the above-mentioned first embodiment is applied except for the points mentioned later.

In one example of the host vehicle 1 to which the traveling control device 14 of the fifth embodiment is applied, in the same way as the example of the host vehicle 1 to which the traveling control device 14 of the above-mentioned fourth embodiment is applied, the traveling control device 14 is configured by the autonomous driving ECU.

In the example of the host vehicle 1 to which the traveling control device 14 of the fifth embodiment is applied, the control unit 3D of the traveling control device 14 of the fifth embodiment activates the steering actuator 15A, the braking actuator 15B, the drive actuator 15C, the left turn blinker 15D, and the right turn blinker 15E operate based on the result of prediction of the prediction unit 3C of the traveling control device 14 of the fifth embodiment by using a model obtained by performing learning using teacher data which is, for example, a set of the result of prediction of the prediction unit 3C and the content of the control of the control unit 3D in the above-mentioned examples shown in FIG. 1 to FIG. 10.

As explained above, although the embodiments of the traveling control device, the traveling control method, and the non-transitory recording medium of the present disclosure were explained with reference to the drawings, the traveling control device, the traveling control method, and the non-transitory recording medium of the present disclosure are not limited to the above-mentioned embodiments and may be suitably changed without departing from the gist of the present disclosure. The constitutions of each example of the embodiment explained above may be suitably combined. In each example of the embodiment explained above, the process performed in the traveling control device 14 was explained as software process performed by executing the program, but the process performed in the traveling control device 14 may also be the process performed by hardware. Alternatively, the process performed in the traveling control device 14 may be the process combining both software and hardware. Further, the program (program for realizing the function of the processor 143 of the traveling control device 14) stored in the memory 142 of the traveling control device 14 may, for example, be recorded in a computer readable storage medium (non-transitory recording medium) such as semiconductor memory, magnetic recording medium, optical recording medium, or the like and supplied, distributed, etc. . . . .

The traveling control devices 14 of the first to fifth embodiments applied to a host vehicle 1 configured so as to drive on a road of a country having regulations requiring vehicles to drive on the left-hand side were explained, but the traveling control devices (not shown) applied to the host vehicle (not shown) configured so as to drive on a road of a country having regulations requiring vehicles to drive on the right-hand side can be realized by reading the “left” and “right” in the above explanation reversed.

Specifically, aspects of the traveling control device, the traveling control method, and the non-transitory recording medium applied to the host vehicle configured so as to drive on a road of a country having regulations requiring vehicles to drive on the right-hand side are as shown in the claims.

1. A traveling control device comprising a processor configured to:
acquire result of detection of a surrounding situation sensor detecting a surrounding situation of a host vehicle driving on the right side of a road, the surrounding situation including a following vehicle positioned within a certain distance behind the host vehicle;
calculate a change in traveling behavior of the following vehicle in a time period before and after a time point when a right turn blinker of the host vehicle is turned on based on the result of detection; and
predict the traveling behavior of the following vehicle before the host vehicle turns right or while the host vehicle is turning right based on the change in the traveling behavior of the following vehicle in the time period before and after the time point when the right turn blinker of the host vehicle is turned on.

2. The traveling control device according to claim 1, wherein the processor is configured to control traveling of the host vehicle before the host vehicle turns right based on the traveling behavior of the following vehicle before the host vehicle turns right or while the host vehicle is turning right.

3. The traveling control device according to claim 2, wherein the processor is configured to predict that the following vehicle is waiting for the host vehicle to finish turning right when a width direction position of the following vehicle in a traveling lane in the time period before and after the time point when the right turn blinker is turned on does not change and when a speed of the following vehicle in the time period after the time point when the right turn blinker is turned on is lower than the speed of the following vehicle in the time period before the time point when the right turn blinker is turned on.

4. The traveling control device according to claim 3, wherein the processor is configured to make the host vehicle decelerate and make the width direction position of the host vehicle in the traveling lane gradually move to the right side when the processor predicts that the following vehicle is waiting for the host vehicle to finish turning right.

5. The traveling control device according to claim 2, wherein the processor is configured to predict that there is a possibility that the following vehicle slips through the right side of the host vehicle when a width direction position of the following vehicle in a traveling lane in the time period before and after the time point when the right turn blinker is turned on does not change or the width direction position of the following vehicle in the traveling lane in the time period after the time point when the right turn blinker is turned on moves to the right side of the width direction position of the following vehicle in the traveling lane in the time period before the time point when the right turn blinker is turned on and when a speed of the following vehicle in the time period after the time point when the right turn blinker is turned on is higher than the speed of the following vehicle in the time period before the time point when the right turn blinker is turned on.

6. The traveling control device according to claim 5, wherein the processor is configured to make the host vehicle decelerate without making the width direction position of the host vehicle in the traveling lane change when the processor predicts that there is the possibility that the following vehicle slips through the right side of the host vehicle.

7. The traveling control device according to claim 2, wherein the processor is configured to predict that the following vehicle is waiting for the host vehicle to finish turning right or there is a possibility that the following vehicle slips through the right side of the host vehicle when a width direction position of the following vehicle in a traveling lane in the time period before and after the time point when the right turn blinker is turned on does not change and when a speed of the following vehicle in the time period before and after the time point when the right turn blinker is turned on does not change.

8. The traveling control device according to claim 7, wherein the processor is configured to perform control for making the host vehicle decelerate without making the width direction position of the host vehicle in the traveling lane change when the processor predicts that the following vehicle is waiting for the host vehicle to finish turning right or there is the possibility that the following vehicle slips through the right side of the host vehicle.

9. The traveling control device according to claim 8, wherein the processor is configured to predict that the following vehicle is waiting for the host vehicle to finish turning right when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is lower than the speed of the following vehicle in the time period before the time point when the processor performs the control for making the host vehicle decelerate without making the width direction position of the host vehicle in the traveling lane change.

10. The traveling control device according to claim 8, wherein the processor is configured to predict that there is the possibility that the following vehicle slips through the right side of the host vehicle when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is not lower than the speed of the following vehicle in the time period before the time point when the processor performs the control for making the host vehicle decelerate without making the width direction position of the host vehicle in the traveling lane change.

11. The traveling control device according to claim 2, wherein the processor is configured to predict that the following vehicle is waiting for the host vehicle to finish turning right or there is a possibility that the following vehicle slips through the right side of the host vehicle when a width direction position of the following vehicle in a traveling lane in the time period after the time point when the right turn blinker is turned on moves to the right side of the width direction position of the following vehicle in the traveling lane in the time period before the time point when the right turn blinker is turned on and when a speed of the following vehicle in the time period after the time point when the right turn blinker is turned on is lower than the speed of the following vehicle in the time period before the time point when the right turn blinker is turned on.

12. The traveling control device according to claim 11, wherein the processor is configured to perform control for making the host vehicle decelerate without making the width direction position of the host vehicle in the traveling lane change when the processor predicts that the following vehicle is waiting for the host vehicle to finish turning right or there is the possibility that the following vehicle slips through the right side of the host vehicle.

13. The traveling control device according to claim 12, wherein the processor is configured to predict that the following vehicle is waiting for the host vehicle to finish turning right when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is lower than the speed of the following vehicle in the time period before the time point when the processor performs the control for making the host vehicle decelerate without making the width direction position of the host vehicle in the traveling lane change.

14. The traveling control device according to claim 12, wherein the processor is configured to predict that there is the possibility that the following vehicle slips through the right side of the host vehicle when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is not lower than the speed of the following vehicle in the time period before the time point when the processor performs the control for making the host vehicle decelerate without making the width direction position of the host vehicle in the traveling lane change.

15. The traveling control device according to claim 2, wherein the processor is configured to predict that the following vehicle is waiting for the host vehicle to finish turning right or there is a possibility that the following vehicle slips through the right side of the host vehicle when a width direction position of the following vehicle in a traveling lane in the time period after the time point when the right turn blinker is turned on moves to the right side of the width direction position of the following vehicle in the traveling lane in the time period before the time point when the right turn blinker is turned on and when a speed of the following vehicle in the time period before and after the time point when the right turn blinker is turned on does not change.

16. The traveling control device according to claim 15, wherein the processor is configured to perform control for making the host vehicle decelerate without making the width direction position of the host vehicle in the traveling lane change when the processor predicts that the following vehicle is waiting for the host vehicle to finish turning right or there is the possibility that the following vehicle slips through the right side of the host vehicle.

17. The traveling control device according to claim 16, wherein the processor is configured to predict that the following vehicle is waiting for the host vehicle to finish turning right when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is lower than the speed of the following vehicle in the time period before the time point when the processor performs the control for making the host vehicle decelerate without making the width direction position of the host vehicle in the traveling lane change.

18. The traveling control device according to claim 16, wherein the processor is configured to predict that there is the possibility that the following vehicle slips through the right side of the host vehicle when the processor performs the control for making the host vehicle decelerate without making the width direction position of the host vehicle in the traveling lane change and when the speed of the following vehicle in the time period after the time point when the processor performs the control for making the host vehicle decelerate without making the width direction position of the host vehicle in the traveling lane change is not lower than the speed of the following vehicle in the time period before the time point when the processor performs the control for making the host vehicle decelerate without making the width direction position of the host vehicle in the traveling lane change.

19. The traveling control device according to claim 2, wherein the processor is configured to predict that there is a possibility that the following vehicle overtakes the host vehicle from the left side of the host vehicle when a width direction position of the following vehicle in a traveling lane in the time period after the time point when the right turn blinker is turned on moves to the left side of the width direction position of the following vehicle in the traveling lane in the time period before the time point when the right turn blinker is turned on.

20. The traveling control device according to claim 19, wherein the processor is configured to make the host vehicle decelerate and make the width direction position of the host vehicle in the traveling lane gradually move to the right side when the processor predicts that there is the possibility that the following vehicle overtakes the host vehicle from the left side of the host vehicle.

21. A traveling control method comprising:
acquiring result of detection of a surrounding situation sensor detecting a surrounding situation of a host vehicle driving on the right side of a road, the surrounding situation including a following vehicle positioned within a certain distance behind the host vehicle;
calculating a change in traveling behavior of the following vehicle in a time period before and after a time point when a right turn blinker of the host vehicle is turned on based on the result of detection; and
predicting the traveling behavior of the following vehicle before the host vehicle turns right or while the host vehicle is turning right based on the change in the traveling behavior of the following vehicle in the time period before and after the time point when the right turn blinker of the host vehicle is turned on.

22. A non-transitory recording medium having recorded thereon a computer program for causing a processor to perform a process comprising:
acquiring result of detection of a surrounding situation sensor detecting a surrounding situation of a host vehicle driving on the right side of a road, the surrounding situation including a following vehicle positioned within a certain distance behind the host vehicle;
calculating a change in traveling behavior of the following vehicle in a time period before and after a time point when a right turn blinker of the host vehicle is turned on based on the result of detection; and
predicting the traveling behavior of the following vehicle before the host vehicle turns right or while the host vehicle is turning right based on the change in the traveling behavior of the following vehicle in the time period before and after the time point when the right turn blinker of the host vehicle is turned on.
